(19) United States
(12) Patent Application Publication
(10) Pub. No.: US 2014/0079848 A1
(43) Pub. Date: Mar. 20, 2014

(54) FREEZABLE DAIRY PRODUCT

(71) Applicant: DANONE S.A., Barcelona (ES)

(72) Inventors: Cristina Sanchez Rams, Barcelona (ES); Elena Vela Roca, Barcelona (ES); Blanca Torrella Latorre, Barcelona (ES); Maria Luisa Garcia Antolin, Barcelona (ES)

(73) Assignee: DANONE S.A., Barcelona (ES)

(21) Appl. No.: 14/116,117

(22) PCT Filed: May 11, 2012
(86) PCT No.: PCT/EP2012/058727

§ 371 Date: Nov. 6, 2013

Related U.S. Application Data
(60) Provisional application No. 61/584,895, filed on Jan. 10, 2012.

(30) Foreign Application Priority Data
May 11, 2011 (EP) PCT/EP2011/057623

(51) Int. Cl. A23G 9/52

(52) U.S. Cl. CPC A23G 9/52
USPC 426/87; 426/565; 426/548

(57) ABSTRACT

The invention concerns freezable dairy compositions comprising milk, processes for making such compositions and for freezing them, and their uses. The composition has an overrun of from 25% to 150%.

The invention concerns freezable dairy compositions comprising milk, processes for making such compositions and for freezing them, and their uses.

Dairy compositions stored at chilled temperatures are appreciated by consumers, for example as a healthy nutrition due to milk. Frozen compositions such as ice-creams or frozen yogurts are appreciated by consumers, for example because they provide some indulgence and pleasure. The frozen temperatures are also appreciated by consumers as refreshing.

However chilled products and frozen products are transported and stored via different logistic channels, and do not provide to the consumer any choice as to home storage and consumption. Moreover, storage and transportation at frozen temperatures require much energy and/or care, either from the plant to the distribution site (store or restaurant), or from the distribution site to the consumer's site of use, for example the consumer's home.

Thus, there is a need for products that can be stored at chilled temperatures, and which can be frozen in a different location, typically at the consumer's site of use.

Document WO 2009/000535 describes frozen food compositions comprising long chain inulin. Said inulin is reported as avoiding growth of ice crystals upon heat shock cycle from −25° C. to −15° C. and back to −25° C. The composition is aerated and frozen before storage. Examples of compositions comprise cream, whole milk, non-fat milk, sucrose, inulin, an emulsifier, polysaccharides and gums. The process and the compositions are not adapted to versatile consumption as a fresh dairy product or as a frozen product. There is thus a need for other products and/or other uses.

Document EP 1882418 describes aerated frozen food compositions comprising probiotics. The compositions are low-fat compositions with high content of viable probiotics, and small crystal sizes (lower than 55 μm). The compositions are aerated and frozen before storage. The compositions comprise skimmed milk, vegetal oil, emulsifiers, sucrose, fructose, and gums. The process and the compositions are not adapted to versatile consumption as a fresh dairy product or as a frozen product. There is thus a need for other products and/or other uses.

Document EP 1430785 describes aerated ice-cream yogurt compositions and processes. The compositions are aerated and frozen before storage. Examples of compositions comprise cream, whole yogurt, fructose, inulin, fibers, and milk proteins. The process and the compositions are not adapted to versatile consumption as a fresh dairy product or as a frozen product. There is thus a need for other products and/or other uses.

Document WO 02/080693 describes aerated frozen food compositions comprising maltose and sucrose sweeteners. The association of sweeteners is said to improve the crystal size stability. The compositions are aerated and frozen before storage. Examples of compositions comprise sucrose, maltose, non-fat milk solids, and fat. Comparative examples comprise cream, skimmed milk, sucrose, emulsifiers, and gums. The process and the compositions are not adapted to versatile consumption as a fresh dairy product or as a frozen product. There is thus a need for other products and/or other uses.

Document U.S. Pat. No. 6,551,646 describes a process for making frozen food compositions, comprising freezing before storage. The process is not adapted to versatile consumption as a fresh dairy product or as a frozen product. There is thus a need for another process.

Documents WO 01/06865 and U.S. Pat. No. 7,727,573 describe aerated frozen food compositions comprising particular emulsifiers that allow formation of alpha fat crystals. This is reported as allowing fine aerated structure and high resistance to heat shocks. The compositions are aerated and frozen before storage. Examples of compositions comprise fat, whey solids, sugar, syrup, gums, emulsifiers, and water. The process and the compositions are not adapted to versatile consumption as a fresh dairy product or as a frozen product. There is thus a need for other products and/or other uses.

Document WO 00/49883 describes aerated frozen food compositions comprising non-fat milk, milk, fat, sucrose, syrup, dextrose, starch, and gums. The compositions are aerated and frozen before storage. The process and the compositions are not adapted to versatile consumption as a fresh dairy product or as a frozen product. There is thus a need for other products and/or other uses.

Document WO 99/37164 describes frozen food compositions comprising Anti-Freezing Peptides (AFPs), said compositions having small size ice crystals after storage for 3 weeks at −10° C. Examples of compositions comprise Anti-Freezing Peptides, sugar, skim milk, fat, gums, monoglyceride, sucrose and maltodextrine. The compositions are frozen before storage. The process and the compositions are not adapted to versatile consumption as a fresh dairy product or as a frozen product. There is thus a need for other products and/or other uses.

Document JP 11-155490 describes compositions that can be distributed at ordinary temperature and frozen. Examples of compositions include gums, cream, sugar, milk, cyclodextrine, and wine. However the compositions are not aerated and cannot be easily scooped. There is thus a need for other products.

Document WO 93/02567 describes frozen food compositions. The compositions are aerated and frozen before storage. Examples of compositions comprise sucrose, syrup, fat, whey, gums, and emulsifiers. The process and the compositions are not adapted to versatile consumption as a fresh dairy product or as a frozen product. There is thus a need for other products and/or other uses.

Document WO 92/11769 describes frozen food compositions comprising hydrolyzed starch. The compositions are aerated and frozen before storage. Examples of compositions comprise cream, skim milk, egg yolk, sucrose, corn syrup, water and yogurt. The process and the compositions are not adapted to versatile consumption as a fresh dairy product or as a frozen product. There is thus a need for other products and/or other uses.

Document U.S. Pat. No. 4,631,196 describes a low-fat food composition that can be eaten in refrigerated form (at fresh temperatures) or in a frozen form (at freeze temperatures). The composition can be aerated. Examples of composition comprise skimmed milk, water, polydextrose, sodium caseinate, fructose, gelatin, gums and emulsifiers. However the compositions do not comprise cream. This does not allow good properties upon freezing and generate high crystal sizes. There is thus a need for other products and/or other uses.

Some attempts were made to market milk-based compositions stored at chilled temperature, to be frozen at the site of use. However after freezing these products did not provide good usage properties. Some would form crystals upon freezing, some would have a very low ability to be scooped and/or would require a very long time at room temperature before being easily scooped. The need for freezable products with good properties remained unaddressed so far.

The invention addresses at least one of the problems or needs mentioned above, with the use of a dairy composition comprising milk, stored at a temperature of from 0.5 to 10° C., for preparing a frozen composition by freezing at a temperature of from −25° C. to −0.5° C., wherein:

the composition comprises gas inclusions, and

the composition has an overrun of from 25% to 150%, preferably of from 25% to 50% or of from 50% to 150% or of from 75% to 125% or of from 60% to 100%.

Surprisingly it has been found that such compositions allow good usage properties when frozen, including a very good ability to be scooped and/or a low crystallization, as well as good properties when stored at fresh temperature, including stability.

The invention also concerns a particular dairy composition. This particular composition is especially adapted, over other compositions, for storage at a temperature of from 0.5 to 10° C., and freezing at a temperature of from −25° C. to −0.5° C.

The invention also concerns a process of preparing a dairy composition. The invention also concerns a process of preparing a frozen composition. The invention also concerns a method of use of the dairy composition.

### DEFINITIONS

In the present specification “storage” of a product refers to storage during at least 24 hours, preferably at least 48 hours, preferably at fresh temperature. The stored product is typically a composition contained in a container, typically a food container. Storage can include a phase wherein the product is left to rest, typically on store shelves and/or in consumers' refrigerators. Storage can include a phase of transportation, typically transportation of the container. Transportation can be performed for example in vehicle such as a truck, train, boat or plane, or a combination thereof.

In the present specification “fresh temperature” or “chilled temperature” refers to a temperature of from 0.5° C. to 10° C., typically to a temperature of a refrigerator (including for example cold storage room, cold transportation vehicles, display refrigerators in stores or domestic refrigerators).

In the present specification “freeze temperature” or “frozen temperature” refers to a temperature of from −25° C. to −0.5° C., preferably from −25° C. to −15° C., preferably from −25° C. to −18° C., typically to a temperature of a freezer (including for example storage room under freezing conditions, freeze transportation vehicles, display freezers in stores or domestic freezers, either isolated or compartment of a refrigerator).

In the present specification the overrun designates the % increase in volume of composition due to gas inclusions, compared to the volume of the composition without the gas inclusions. The overrun can be calculated from the following equation:

% Overrun=100% * [(Volume of composition with gas inclusions)−(Volume of composition without gas inclusions)]/(Volume of composition without gas inclusions).

The overrun can also be calculated from the density of the composition (weight per volume), using a density value of the composition without the gas inclusions of 1.14. Herein a density of 0.76 g/cm³ is considered as corresponding to an overrun of 50%, a density of 0.65 is considered as corresponding to an overrun of 75%, a density of 0.57 is considered as corresponding to an overrun of 100%, a density of 0.51 is considered as corresponding to an overrun of 125%, and a density of 0.46 is considered as corresponding to an overrun of 150%.

In the present specification the use of a product is intended to cover the use itself, optionally with the connected intention, but also to cover any communication with commercial or legal potential consequences, associated to the product, for example advertisement, indications, instructions or recommendations on the package of product, indications, instructions or recommendations on commercial support such as leaflets, brochures, posters, websites. Instructions, indications, or recommendations can be provided in a written form and/or in an image form, such as a picture, a drawing, a scheme, a photograph or a film.

### Composition

The composition comprises gas inclusions. The gas can be any safe gas, such as nitrogen, oxygen or mixtures thereof. The gas in the composition is typically air. The gas is typically present as gas bubbles in the composition matrix. The matrix can be a liquid, a viscous fluid or a solid. At fresh temperature the matrix and the gas inclusions typically form a mousse wherein the matrix is not solid. At this temperature, without the gas inclusions, the matrix is typically a liquid gel. At frozen temperature the matrix is typically in a solid form.

It is preferred that the density of the composition at fresh temperature be of from 0.46 to 0.76 g/cm³, preferably of from 0.51 to 0.65 g/cm³, for example of about 0.57 g/cm³.

It is mentioned than the overrun can be different from 150%, it can be typically of less than 150%.

The gas inclusions can be created by aerating the composition, thus providing an overrun. Such operations are known by the one skilled in the art. One can for example use adapted foaming machines. Interesting equipments include equipments marketed by Mondomix, such as Mondomix UA-05 or Mondomix E50.

In a preferred embodiment the gas inclusions are present in the composition during a storage time of at least 7 days, preferably at least 14 days, preferably at least 21 days, preferably at least 30 days, preferably at least 40 days, preferably at fresh temperature.

When the composition is frozen (after freezing), it is preferred that the composition does not comprise crystals that can be perceived on the tongue, for example crystals having an average size of 70 to 250 μm (determined by microscopy). It is believed that a crystal size below 70 μm provides a product that is very creamy with almost no organoleptic perception of ice. It is believed that a crystal size from 70 to 250 μm provides a product that is refreshing while still creamy with some perception of crystals. It is believed that a crystal size above 250 μm causes quality issues with bad organoleptic perception of crystals. Preferably the frozen composition is substantially depleted of ice crystals or presents ice crystals having a size (for example an average size) of less then 250 μm, preferably of less than 150 μm, preferably of less than 70 μm.

The composition comprises milk, typically animal milk. The animal milk is typically cow milk, but one can use alternative animal milks such as sheep milk or goat milk. One can use milk substitutes, also referred to as vegetal milk, for example soya milk. Milks, either animal or vegetal, typically comprise proteins (at least 1% by weight). Animal milk for example typically comprises casein. Any type of animal milk can be used, such as full milk, partially or totally skimmed milk, skimmed milk powder etc. . . . . The milk present in the composition can be introduced completely or partly in a milk powder form.

The composition is typically an aqueous composition comprising water and milk components different from water. The water present in the composition can come from the milk, typically if the milk is not in a powder form, and/or the water can come from added water.

The composition can be a fermented or non fermented dairy composition. Such compositions are known be the one skilled in the art.

Fermented products typically comprise microorganisms, such as lactic acid bacteria and/or probiotics (the probiotics can be lactic acid bacteria). These are also referred to as ferments or cultures or starters. Lactic acid bacteria are known by the one skilled in the art. Probiotics are also known by the one skilled in the art. Examples of probiotics include some Bifidobacteria and Lactobacilli, such as Bifidobacterium brevis, Lactobacillus acidophilus, Bifidobacterium animalis, Bifidobacterium animalis lactis, Bifidobacterium infantis, Bifidobacterium longum, Lactobacillus casei, Lactobacillus casei paracasei, Lactobacillus reuteri, Lactobacillus plantarum, or Lactobacillus rhamnosus. In one embodiment the product is a fermented milk product or a yogurt. It is mentioned that yogurts are considered as being specific fermented milk products.

Fermented animal milk products are known by the one skilled in the art. Such products are made from animal milk (with further additives), and have undergone a fermentation step. The fermentation is typically done by microorganisms such as bacteria and/or yeasts, preferably at least bacteria, preferably lactic acid bacteria, and leads to the production of fermentation products, for example lactic acid, and/or to the multiplication of the microorganisms. The designation “fermented milk” can depend on local legislation, but is typically given to a dairy product prepared from skimmed or full fat milk, or concentrated or powdered milk, having undergone a heat treatment at least equivalent to a pasteurization treatment, and inoculated with lactic acid producing microorganisms such as Lactobacilli (Lactobacillus acidophilus, Lb. casei, Lb. plantarum, Lb. reuteri, Lb. johnsonii), certain Streptococci (Streptococcus thermophilus), Bifidobacteria (Bifidobacterium bifidum, B. longum, B. breve, B. animalis) and/or Lactococci (Lactococcus lactis).

Fermented vegetal milk products are known by the one skilled in the art. Such products are essentially made up of vegetal milk, having a vegetal extract as a major constituent beyond water, and have undergone a fermentation step. The fermentation is typically done by microorganisms such as bacteria and/or yeasts, preferably at least bacteria, and leads to the production of fermentation products, for example lactic acid, and/or to the multiplication of the microorganisms. By vegetal extract as a major constituent, it is typically referred to a vegetal content at least equal to 50% by weight of dry matter, preferably from 70% to 100%. The vegetal milk can be for example soya milk, oat milk, rice milk, almond milk, rice milk or rice beverage or a mixture thereof.

If the composition is a fermented composition, it typically comprises lactic acid bacteria. The lactic acid bacteria typically comprise a mixture of Streptococcus thermophilus and Lactobacillus delbrueckii subsp. Bulgaricus.

In one embodiment, the composition is a fermented dairy composition, and is obtained by mixing:

a composition different from a fermented dairy composition, such as a non fermented dairy composition or a syrup composition, and

an intermediate fermented dairy composition.

In such a case, typically, the ratio between the intermediate fermented dairy composition and the composition different from a fermented dairy composition (such as a non fermented dairy composition or syrup composition) can be of from 1/99 to 99/1, preferably of from 5/95 to 95/5, for example between 5/95 and 50/50.

Herein a syrup composition typically refers to an intermediate composition that does not comprise milk.

The composition can typically comprise:

a) milk,
b) cream,
c) a polyol,
d) an emulsifier, and
e) optionally a gelling and/or thickening agent, orf) optionally a taste additive.

In a preferred embodiment the composition comprises:

a) milk,
b) cream,
c) a polyol,
d) an emulsifier,
e) optionally a gelling and/or thickening agent, and
f) optionally a taste additive.

As mentioned above the milk a) can be fermented or non fermented.

Cream is an ingredient commonly used in the art of preparing ice-creams and/or dairy products. This ingredient is known by the one skilled in the art. Cream can be for example milk cream or buttermilk.

In one embodiment the polyol is xylitol. Xylitol is believed to provide good freezing behavior, preventing crystal formation by lowering the freezing point, while minimizing laxative effects. The polyol is typically different from sugar, glucose, fructose, lactose, sucrose, saccharose, galactose, maltose, mannose, dextrose or a mixture thereof; herein considered as taste additives.

The emulsifier is believed to allow the formation of gas inclusions which remain in the composition when stored at a fresh temperature. In one embodiment the emulsifier is an ester of a fatty acid glyceride, for example a lactic acid ester of mono- and diglycerides of fatty acids, for examples ingredients known as LACTEM.

The optional gelling and/or thickening agent can provide some further stability of the gas inclusions and/or some appropriate texture. One can use a mixture of gelling and/or thickening agents. The gelling and/or thickening agent can be for example gelatin, a carrageenan, a locust bean gum, an alginate, a pectin, a xanthan gum or a mixture or an association thereof. In one embodiment the gelling and/or thickening agent is gelatin. In one embodiment the gelling and/or thickening agent is xanthan gum. In one embodiment the gelling and/or thickening agent is a mixture or an association of gelation and xanthan gum. In some embodiments the gelling and/or thickening agent is a carrageenan, a locust bean gum, an alginate or a pectin.

In a preferred embodiment the composition is substantially free of flours and/or starches. Herein “substantially free” refers to amounts of less than 0.2%, preferably less than 0.1%, preferably less than 0.05%, preferably less than 0.01%, preferably 0%.

In one embodiment the composition comprises taste additives. Such additives may include flavors, perfumes, fruits or fruit extracts, nuts, sweetening agents, acidity modifiers etc. . . . . In one embodiment the taste additive comprises sugar. Beyond modifying taste, sugar can contribute to increasing the dry matter of the composition. The sugar can be for example glucose, fructose, lactose, sucrose, saccharose, galactose, maltose, mannose, dextrose or a mixture thereof. The taste additive is typically different from xylitol, herein considered as a non optional polyol.

It is mentioned that the composition can comprise further ingredients, for example fibers. The composition can for example comprise polydextrose, maltodextrines and/or inuline. Such ingredients can provide digestive benefits and/or can contribute to increase the dry matter of the composition and/or its stability.

The composition has preferably a dry matter of at least 25% by weight, preferably of from 25 to 67%, preferably of from 37 to 60%, preferably of from 40 to 50%. It is believed that if the dry matter is too low, the composition will present crystals after freezing. The dry matter can be adjusted by varying the amounts of the various ingredients. This is known by the one skilled in the art.

The composition has preferably a fat content of from higher than 0% to 20% by weight, preferably from higher than 0% to 3% or from 3 to 20%, preferably of from 5 to 15% or from 1 to 8% or from 3 to 8% or from 5 to 8%. The fat content can be adjusted by varying the amounts and nature of the various ingredients. This is known by the one skilled in the art. For example if one uses skimmed milk, one will use more cream than if one uses full milk. It is believed that the presence of fat can help in incorporating the gas inclusions, by giving body to the frozen composition. It is believed that the presence of fat can also help in improving organoleptic properties, increasing flavor perceptions, and/or improving melting or softening of the frozen composition when said frozen composition is placed at ambient temperature.

The one skilled in the art can adjust the nature and amounts of the ingredients to obtain the required dry matter and/or the required fat content.

The composition has preferably an energy content by volume, expressed per 125 ml, of less than 150 kcal, preferably less than 125 kcal, preferably less than 100 kcal. The composition has preferably an energy content by weight, expressed per 100 g, of less than 225 kcal, preferably less than 188 kcal, preferably less than 150 kcal. The composition has preferably an energy content both by volume, expressed per 125 ml, and by weight, expressed per 100 g, of respectively less than 150 kcal (volume) and 225 kcal (weight), preferably less than 125 kcal (volume) and 188 kcal (weight), preferably 100 kcal (volume) and 150 kcal (weight).

The one skilled in the art can adjust the nature and amounts of the ingredients to obtain the required energy content.

In a particular embodiment the composition comprises:

from 2% to 12% by weight, preferably from 2% to 4% or from 4% to 12% or from 5 to 10%, of a polyol c)

from 0.1 to 3% by weight, preferably from 0.1 to 2%, preferably from 0.25 to 1.5%, preferably from 0.25 to 0.75%, of an emulsifier d)

if present, from 0.1 to 3% by weight, preferably from 0.1 to 2%, preferably from 0.25 to 1.5%, preferably from 0.25 to 1%, preferably from 0.25 to 0.75% by weight, of a gelling and/or thickening agent e),

and the composition comprises:

a dry matter of from 25 to 67% by weight, and

a fat content of from higher than 0% to 20% by weight, preferably from higher than 0% to 3% or from 3% to 20%, or from 3% to 8% or from 5% to 8%.

In a particular embodiment, the composition comprises:

from 20 to 70% by weight of milk a),

from higher than 0% to 50% by weight, preferably from higher than 0% to 5% or from 5% to 40% or from 40% to 50%, of cream b),

from 5 to 25% by weight of a taste additive f), preferably sugar, and wherein:

the composition has a dry matter of from 37 to 60% by weight, and

the composition has a fat content of from higher than 0% to 20% by weight, preferably from higher than 0% to 5% or from 5% to 15% or from 15% to 20% or from 3% to 8% or from 5% to 8%.

### Particular Composition

The invention also concerns a particular composition. This particular composition is useful for the use detailed in the present application. Thus the invention also concerns a dairy composition comprising:

a) milk,
b) cream,

### c) Xylitol,

d) an emulsifier,
e) a gelling and/or thickening agent, and
f) a taste additive, preferably sugar,
wherein:

the composition comprises gas inclusions, and

the composition has an overrun of from 25% to 150%, preferably of from 25 to 50% or of from 50% to 150% or of from 75% to 125% or of from 60% to 100%.

Further details mentioned above about the ingredients and amounts for the composition can be applied to the particular composition. In a preferred embodiment of the particular composition, the gelling and/or thickening agent is gelatin and/or xanthan gum. In a preferred embodiment of the particular composition, the gelling and/or thickening agent is gelatin and/or xanthan gum and the taste additive comprises sugar.

The particular composition preferably comprises:

from 2% to 12% by weight, preferably 2% to 4% or from 4 to 12% or from 5% to 10%, of xylitol c),

from 0.1 to 3% by weight, preferably from 0.1 to 2%, preferably from 0.25 to 1.5%, preferably from 0.25 to 0.75%, of an emulsifier d),

from 0.1 to 3% by weight, preferably from 0.1 to 2%, preferably from 0.25 to 1.5%, preferably from 0.25 to 1%, preferably from 0.25 to 0.75% by weight of a gelling and/or thickening agent e),

and the composition comprises:

a dry matter of from 25 to 67% by weight, and

a fat content of from higher than 0% to 20% by weight, preferably from higher than 0% to 3% or from 3 to 20% or from 3% to 8% or from 5% to 8%.

The particular composition preferably comprises:

from 20 to 70% by weight of milk a),

from higher than 0% to 50% by weight, preferably form higher than 0% to 5% or from 5% to 40% or from 40% to 50%, of cream b),

from 5 to 40% by weight of a taste additive f), preferably sugar and/or lactose and/or glucose and/or polydextrose.

wherein:
the composition has a dry matter of from 37 to 60% by weight, and

the composition has a fat content of from higher than 0% to 15% by weight, preferably from higher than 0% to 3% or from 3% to 5% by weight or from 5% to 15% or from 3% to 8% or from 5% to 8%, for example of from 4% to 6%.

In one embodiment referred to as “embodiment A” the particular composition comprises:

from 3 to 10% by weight of xylitol c),

from 0.1 to 3% by weight, preferably from 0.1 to 2%, preferably from 0.25 to 1.5%, preferably from 0.25 to 0.75%, of an emulsifier d),

from 0.1 to 3% by weight, preferably from 0.1 to 2%, preferably from 0.25 to 1.5%, preferably from 0.25 to 0.75% by weight of a gelling and/or thickening agent e), and the composition comprises:

a dry matter of from 25 to 67% by weight, and

a fat content of from 5 to 20% by weight.

In embodiment A, the particular composition preferably comprises:

from 20 to 70% by weight of milk a),

from 40 to 50% by weight of cream b),

from 5 to 25% by weight of a taste additive f), preferably sugar,

wherein:

the composition has a dry matter of from 37 to 60% by weight, and

the composition has a fat content of from 15% to 20% by weight.

In one embodiment referred to as “embodiment B1” the particular composition comprises:

from 3 to 10% by weight of xylitol c),

from 0.1 to 3% by weight, preferably from 0.1 to 2%, preferably from 0.25 to 1.5%, preferably from 0.25 to 0.75%, of an emulsifier d),

from 0.1 to 3% by weight, preferably from 0.1 to 2%, preferably from 0.25 to 1.5%, preferably from 0.25 to 0.75% by weight of a gelling and/or thickening agent e), and the composition comprises:

a dry matter of from 25 to 67% by weight, and

a fat content of from 3 to 10% by weight.

In embodiment B, the particular composition preferably comprises:

from 20 to 70% by weight of milk a),

from 5 to 40% by weight of cream b),

from 5 to 25% by weight of a taste additive f), preferably sugar,

wherein:

the composition has a dry matter of from 37 to 60% by weight, and

the composition has a fat content of from 3 to 10% by weight, preferably from 3% to 8% or from 5% to 8%.

In one embodiment referred to as “embodiment B2” the particular composition comprises:

from 3 to 10% by weight of xylitol c),

from 0.1 to 3% by weight, preferably from 0.1 to 2%, preferably from 0.25 to 1.5%, preferably from 0.25 to 0.75%, of an emulsifier d),

from 0.1 to 3% by weight, preferably from 0.1 to 2%, preferably from 0.25 to 1.5%, preferably from 0.25 to 0.75% by weight of a gelling and/or thickening agent e), and the composition comprises:

a dry matter of from 25 to 67% by weight, and

a fat content of from 3 to 10% by weight.

In embodiment B, the particular composition preferably comprises:

from 20 to 70% by weight of milk a),

from 5 to 40% by weight of cream b),

from 5 to 25% by weight of a taste additive f), preferably sugar,

wherein:

the composition has a dry matter of from 37 to 60% by weight, and

the composition has a fat content of from 3 to 10% by weight.

### Containers

The dairy composition is typically comprised in a container. Preferably the container is closed with a seal. The seal is preferably a soft seal such as a metal foil or a plastic foil. The container can further have a rigid cover. Such containers, seals and covers are known by the one skilled in the art. These can be for example conventional ice-cream containers. Preferably the seal is not removed before freezing. Thus the composition is preferably not agitated during freezing.

The container can be for example a 125 ml or 125 g container, a 200 ml or 200 g container, a 250 ml or 250 g container, a 500 ml or 500 g container, a 750 ml or 750 g container, a 1 l or 1 kg container, or a 1.5 l or 1.5 kg container.

The container can typically present written instructions and/or suggestions to freeze it. Thus the container can comprise ink on its surface or on the surface of a secondary or tertiary packaging element, arranged such that this ink is visible and provides instructions and/or suggestions to freeze.

Process of Making Compositions

The dairy compositions can be prepared by any appropriate process. Typically the dairy composition can be made by a process comprising the following steps:

Step A): mixing all the components a) to d), optionally e) and optionally f),
Step B): subjecting the mixture obtained at step A) to a gas, to provide the overrun.

Typically a production procedure will also include the steps of:

Step C): introducing the composition obtained at step B) in a container and sealing the container,
Step D): storing the composition in the container obtained at step C) at a temperature of from 0.5 to 10° C. during at least 2 days.

Typically the composition can be prepared by a process comprising the following steps:

Step A): mixing all the components a) to d), optionally e) and optionally f),
Step B): subjecting the mixture obtained at step A) to a gas, to provide the overrun,
Step C): introducing the composition obtained at step B) in a container and sealing the container,
Step D): storing the composition in the container obtained at step C) at a temperature of from 0.5 to 10° C. during at least 2 days.

All individual steps and phases therein are well known by the one skilled in the art.

In step A) the ingredients of the composition are mixed. This step can comprise treatments and/or transformations such as heat treatments, homogenization, fermentation, maturation etc. . . . . Such treatments and transformations are known by the one skilled in the art, they can be preformed in various appropriate orders.

Appropriate mixing orders are known by the one skilled in the art. Mixing steps can for example include hydration steps.

One can implement a homogenization step. Homogenization can be performed for example at a pressure of from 10 to 1000 bars, preferably from 50 to 300 bars.

One can implement a heat treatment to sterilize or pasteurize the milk or mixture. Sterilization can be performed for example at a temperature of from 100° C. to 150° C. Pasteurization can be performed for example at a temperature of 80° C. to less than 100° C.

One can implement a maturation step. Maturation, also referred to as ripening, allows the gelling and/or thickening agents, if present, for example gelatine, to provide the texture. Maturation is typically performed during 3 to 6 hours.

In one embodiment, all or a part of the taste additive(s) are added at the end of step A), for example in the form of a fruit preparation or, preferably, in the form of a syrup composition. The mixture before the addition of the taste additive(s) can be referred to as a white mass or as to a plain mass.

In one embodiment step A) involves mixing a fermented milk composition with a non fermented milk composition or a syrup composition. The non fermented milk composition or the syrup composition can comprises milk and/or water. Preferably the non fermented milk composition or the syrup composition have a dry matter of from 25 to 75% by weight, preferably from 30 to 70%, preferably from 40% to 60%. Some detailed possible steps of step A) are provided below:

In one embodiment step A) comprises the following successive steps:

A0) Providing a mixture of at least milk (i.e. component a)), and components b) c), d), optionally e) and optionally f),
A1) Hydrating, preferably during 15 minutes to 2 hours, for example during 30 minutes to 90 minutes,
A2) Optionally preheating to a temperature of from 50° C. to 90° C.,
A3) Homogenizing, preferably at a pressure of from 10 to 1000 bars, preferably from 50 to 300 bars,
A4) Sterilizing or pasteurizing, preferably at a temperature of from 80° C. to 100° C. or from 100 to 150° C.,
A5) Cooling, preferably at a temperature of from 1° C. to 30° C., preferably from 5° C. to 15° C.,
A6) Maturing, preferably at a temperature of from 1° C. to 30° C., preferably from 5° C. to 15° C.

In an other embodiment step A) comprises the following successive steps:

A0′) Providing a mixture of at least milk (i.e. component a)), and components b) c), d), optionally e) and optionally f),
A1′) Optionally hydrating, preferably during 15 minutes to 2 hours, for example during 30 minutes to 90 minutes,
A2′) Pasteurizing at a temperature of from 80° C. to less than 100° C.,
A3′) Homogenizing, preferably at a pressure of from 10 to 1000 bars, preferably from 50 to 300 bars,
A4′) Adding lactic acid bacteria,
A5′) Fermenting, preferably at a temperature of from 30 to 50° C.,
A6′) Cooling, preferably at a temperature of from 1° C. to 30° C., preferably from 5° C. to 15° C.,
A7′) Maturing, preferably at a temperature of from 1° C. to 30° C., preferably from 5° C. to 15° C.

In one embodiment the process is a mixed process comprising the following procedures:

### Procedure 1:

a0) Providing a mixture of at least water and/or milk (i.e. component a)), and components b) c), d), optionally e) and optionally f),
a1) Hydrating, preferably during 15 minutes to 2 hours, for example during 30 minutes to 90 minutes,
a2) Optionally preheating to a temperature of from 50° C. to 90° C.,
a3) Homogenizing, preferably at a pressure of from 10 to 1000 bars, preferably from 50 to 300 bars,
a4) Sterilizing, preferably at a temperature of from 100 to 150° C.,
a5) Cooling, preferably at a temperature of from 1° C. to 30° C., preferably from 5° C. to 15° C. or at a temperature of from 30° C. to 45° C.,

### Procedure 2:

a0′) Providing a mixture of at least milk (i.e. component a)), and components b) c), d), optionally e) and optionally f),
a1′) Optionally hydrating, preferably during 15 minutes to 2 hours, for example during 30 minutes to 90 minutes,
a2′) Pasteurizing at a temperature of from 80° C. to less than 100° C.,
a3′) Homogenizing, preferably at a pressure of from 10 to 1000 bars, preferably from 50 to 300 bars,
a4′) Adding lactic acid bacteria,
a5′) Fermenting, preferably at a temperature of from 30 to 50° C.,
a6′) optionally cooling preferably at a temperature of from 1° C. to 30° C., preferably from 5° C. to 15° C.,

### Procedure 3:

a7″) Mixing the products obtained at step a5) and a5′) or a6′),
a8″) Cooling, preferably at a temperature of from 1° C. to 30° C., preferably from 5° C. to 15° C.,
a9″) Maturing, preferably at a temperature of from 1° C. to 30° C., preferably from 5° C. to 15° C.

In one embodiment the process is a mixed process comprising the following procedures:

### Procedure 1′:

a0″) Providing a mixture of water and components b) c), d), optionally e) and optionally f),

a1″) Hydrating, preferably during 15 minutes to 2 hours, for example during 45 minutes to 90 minutes,

a2″) Optionally preheating to a temperature of from 50° C. to 90° C.,
a3″) Homogenizing, preferably at a pressure of from 10 to 1000 bars, preferably from 50 to 300 bars,
a4″) Sterilizing, preferably at a temperature of from 100 to 150° C.,
a5″) Cooling, preferably at a temperature of from 1° C. to 30° C., preferably from 5° C. to 15° C. or at a temperature of from 30° C. to 45° C.,

### Procedure 2′:

a0′″) Providing a mixture of at least milk (i.e. component a)), and components b) c), d), optionally e) and optionally f),
a1′″) Optionally hydrating, preferably during 15 minutes to 2 hours, for example during 30 minutes to 90 minutes,
a2′″) Pasteurizing at a temperature of from 80° C. to less than 100° C.,
a3′″) Homogenizing, preferably at a pressure of from 10 to 1000 bars, preferably from 50 to 300 bars,
a4′″) Adding lactic acid bacteria,
a5′″) Fermenting, preferably at a temperature of from 30 to 50° C.,
a6′″) optionally cooling preferably at a temperature of from 1° C. to 30° C., preferably from 5° C. to 15° C.,

### Procedure 3′:

a7″″) Mixing the products obtained at step a5″) and a5′″) or a6′″),
a8″″) Cooling, preferably at a temperature of from 1° C. to 30° C., preferably from 5° C. to 15° C.,
a9″″) Maturing, preferably at a temperature of from 1° C. to 30° C., preferably from 5° C. to 15° C.

### Process of Using Compositions and Method of Use

The dairy composition is used to prepare a frozen composition. Accordingly the dairy composition can be subjected to a freezing step, providing a frozen composition. Freezing is typically performed at a freezing temperature. The frozen compositions can be stored at a frozen temperature.

The process of preparing compositions can thus comprise the following step:

Step E): freezing at a temperature of from −25° C. to −0.5° C.

Thus, the process of preparing a frozen composition according to the invention comprises the process described above, and particularly steps A) to D) above, followed by a further step E) comprising freezing the composition obtained at step D) at a temperature of from −25° C. to −0.5° C.

Freezing is typically performed without agitation. Freezing can be preformed without any agitation, during (as a preferred minimum time) 4 to 6 hours or during 6 to 8 hours, or during 8 to 10 hours, at a temperature of from −15 to −20° C., preferably during 5 hours at a temperature of from −18° C. to −20° C. Freezing can be performed for example in a domestic freezer. Freezing is typically performed while the composition is in the container, preferably sealed.

Instructions and/or suggestions to freeze can be embodied by providing a freeze temperature, and/or by providing a picture or film of a freezing device such as domestic freezers, either isolated or compartment of a refrigerator.

The dairy composition at chilled temperature, and/or the frozen composition, can be used as a food product, by oral ingestion. One can consume the composition directly at chilled storage temperature. One can also consume the composition after freezing. In that case one can leave the composition to rest a few minutes at room temperature before consumption, to further improve softness. Frozen compositions of the invention allow a very quick scoopability, that does not require waiting for a long time at room temperature.

Further details or advantage to the invention might appear in the following non limitative examples.

### EXAMPLES

### Compositions at Chilled Temperature

Some compositions are prepared, using the procedure(s) described below, with the ingredients mentioned below. The amounts are provided as weight % of ingredients “as such” (as opposed to amounts of ingredients as dry matter).
“Mousse 32” is Cremodan Mousse 32 provided by Danisco, which is a mixture of 50% by weight of Gelatine and 50% by weight of Lactic acid esters of mono- and diglycerides of fatty acids.
“SMP” is skimmed milk powder.
The fruit preparation comprises water, sugar, and optionally a fruit extract. The dry matter thereof is of about 40% by weight.
LACTEM is LACTEM PQ22 provided by Danisco
Xanthan is LYGOMME™ MM 900.

### Preparation Procedures

Aerated white masses are prepared according to the procedures described below, then they are mixed with the fruit preparation and optionally chocolate and cocoa. Then the compositions are placed in 125 cups, which are sealed with a foil and a cover. The compositions are stored at a temperature of 4-6° C. These are referred to as “chilled compositions”.

### White Mass Procedure 1

The ingredients are mixed and hydrated during 1 hour at room temperature. Then the mixture is pre-heated at 80° C., homogenized at 100 bars, sterilized at 132° C., and then cooled at 10° C. Then the mixture undergoes maturation during 5 hours at 10° C., and aeration (apparatus available at Mondomix) at a temperature of 4° C., to achieve the overrun.

### White Mass Procedure 2

The ingredients are mixed and hydrated during 1 hour at room temperature. Then the mixture is pre-heated at 80° C., homogenized at 100 bars, sterilized at 132° C., and then cooled at 45° C. and then at 10° C. Then the mixture undergoes maturation during 5 hours at 10° C., and aeration (apparatus available at Mondomix) at a temperature of 4° C., to achieve the overrun.

### White Mass Procedure 3

The procedure involves mixing 80% by weight of white mass a) prepared as follows, and 20% by weight of the white mass b) prepared as follows. The mixture is referred to as white mass c).

White mass a): The ingredients are mixed and hydrated during 1 hour at room temperature. Then the mixture is pre-heated at 80° C., homogenized at 100 bars, sterilized at 132° C., and then cooled at 45° C.
White mass b): The ingredients are mixed and pre-heated at 80° C., pasteurized at 92° C., homogenized at 150 bars. Then the ferment is inoculated, and the mixture is allowed to ferment at 38° C. during 6-8 hours.
White mass c): White mass a) and white mass b) are mixed, and cooled at 4° C. Then the mixture undergoes maturation during 5 hours at 10° C., and aeration (apparatus available at Mondomix) at a temperature of 4° C., to achieve the overrun.

### White Mass Procedure 4

The procedure involves mixing 60% by weight of syrup a) prepared as follows, and 40% by weight of the white mass b) prepared as follows. The mixture is referred to as white mass c).

Syrup a): The ingredients are mixed and hydrated during 1 hour at room temperature. Then the mixture is pre-heated at 63° C., homogenized at 100 bars, sterilized at 132° C., and then cooled at 9° C.
White mass b): The ingredients are mixed and pre-heated at 80° C., pasteurized at 92° C., homogenized at 150 bars. Then the ferment is inoculated, and the mixture is allowed to ferment at 43° C. during 6-8 hours, and then cooled to 9° C.
White mass c): White mass a) and white mass b) are mixed, and cooled at 4° C. Then the mixture undergoes maturation during 5 hours at 10° C., and aeration (apparatus available at Mondomix) at a temperature of 4° C., to achieve the overrun.

### White Mass Procedure 5

The procedure involves mixing 50% by weight of syrup a) prepared as follows, and 50% by weight of the white mass b) prepared as follows. The mixture is referred to as white mass c).

Syrup a): The ingredients are mixed and hydrated during 1 hour at room temperature. Then the mixture is pre-heated at 63° C., homogenized at 100 bars, sterilized at 132° C., and then cooled at 5° C.
White mass b): The ingredients are mixed and pre-heated at 80° C., pasteurized at 92° C., homogenized at 150 bars. Then the ferment is inoculated, and the mixture is allowed to ferment at 43° C. during 6-8 hours, and then cooled to 10° C.
White mass c): White mass a) and white mass b) are mixed, and cooled at 4° C. Then the mixture undergoes maturation during 5 hours at 9° C., and aeration (apparatus available at Mondomix) at a temperature of 4° C., to achieve the overrun.

### Frozen Compositions

The compositions are placed in a domestic freezer at a temperature of −18° C. to −20° C. and allowed to freeze during 5 hours. These are referred to as “frozen compositions”.

### Examples 1 to 3 and Comparative Examples 1 to 4

The compositions reported on table I are prepared.

TABLE I

| | | | | | Comparative | | |
|---|---|---|---|---|---|---|---|
| | | | | | Example 2: No | | |
| | | Example 2: | Example 3: | Comparative | Emulsifier and | Comparative | Comparative |
| | Example 1: | White plain | White plain | Example 1: | gelling and/or | Example 3: | Example 4: |
| Ingredient | Chocolate | non fermented | fermented | No Polyol | thickening agent | No sugar | No cream |
| White mass | Procedure 1 | Procedure 2 | Procedure 3 | Procedure 2 | Procedure 2 | Procedure 2 | Procedure 2 |
| preparation | | | | | | | |
| procedure | | | | | | | |
| Skimmed Milk | 42.34% | 49.52% | 51.44% | 53.25% | 50.53% | 55.64% | 69.53% |
| SMP | 1.03% | 1.7% | 3.29% | 1.83% | 1.73% | 1.91% | 2.38% |
| Cream | 18.85% | 28.77% | 22.01% | 30.94% | 29.36% | 32.33% | / |
| Ferment | / | / | 0.02% | / | / | / | / |
| Polyol | Xylitol: 6% | Xylitol: 7% | Xylitol: 5.5% | / | Xylitol: 7.14% | Xylitol: 7.86% | Xylitol: 9.8% |
| Emulsifier | Mousse 32: 1.8% | Mousse 32: 2% | Mousse 32: 1.58% | 2.15% | / | Mousse 32: 2.24% | Mousse 32: 2.8% |
| Gelling and/or | | | | | / | | |
| thickening agent | | | | | | | |
| Sugar | 9.43% | 11% | 4.04% | 11.83% | 11.22% | / | 15.44% |
| Chocolate powder | 5.4% | / | / | / | / | / | / |
| Cocoa | 2.3% | / | / | / | / | / | / |
| Fruit preparation | 12.8% | / | 12.8% | / | / | / | / |
| Dry Matter | 43.5% | 40% | / | / | / | / | / |
| Fat content | 11.3 g | 10 g | / | / | / | / | / |
| (per 100 g) | | | | | | | |
| Overrun | 100% | 100% | 100% | 100% | 100% | 100% | 100% |

### Evaluations

The compositions are submitted to the various evaluations described and reported below.

Chilled compositions are evaluated for:
stability: organoleptic and visual evaluation of a single mousse phase after storage and transportation; and
mousse texture: organoleptic evaluation.

Frozen compositions are evaluated for:
crystal presence: organoleptic evaluation of the product on the tongue in mouth.

The results are reported on table II below:

TABLE II

| | | | | | Comparative | | |
|---|---|---|---|---|---|---|---|
| | | | | | Example 2: No | | |
| | | Example 2: | Example 3: | Comparative | Emulsifier and | Comparative | Comparative |
| | Example 1: | White plain | White plain | Example 1: | gelling and/or | Example 3: | Example 4: |
| Evaluation | Chocolate | non fermented | fermented | No Polyol | thickening agent | No sugar | No cream |
| Stability | Stable | Stable | Stable | Not stable | Not stable | Not stable | Not stable |
| Mousse Texture | Mousse texture | Mousse texture | Mousse texture | Not frothy, not | Not frothy, not | Not frothy, not | Not frothy, not |
| | (air on tongue) | (air on tongue) | (air on tongue) | spongy | spongy | spongy | spongy |
| Crystal | No presence of | No presence of | No presence of | Presence of ice | Presence of ice | Presence of ice | Presence of ice |
| | crystals on | crystals on | crystals on | crystals on | crystals on | crystals on | crystals on |
| | tongue | tongue | tongue | tongue. | tongue | tongue | tongue |
| | | | | Gummy, brittle | Gummy, brittle | Gummy, brittle | Gummy, brittle |
| | | | | and hard | and hard | and hard | and hard |
| | | | | texture. | texture. | texture. | texture. |

### Example 4

The composition reported on table III is prepared, stored and then frozen.

TABLE III

| Ingredient | Example 4 |
|---|---|
| White mass preparation procedure | Procedure 4 |
| Skimmed Milk | 30.09% |
| SMP | 3.08% |
| Cream | 41.99% |
| Ferment | 0.01% |
| Polyol | Xylitol: 4% |
| Emulsifier | Mousse 32: 0.84% |
| Gelling and/or thickening agent | |
| Sugar | Saccharose: 8.00% |
| Fruit preparation | 12% |
| Dry Matter | 42% |
| Fat content (per 100 g) | 17.1 g |
| Overrun | 100% |

### Example 5

The composition reported on table IV is prepared, stored and then frozen.

The procedure for making the composition is detailed below.

TABLE IV

| Ingredient | Example 5: |
|---|---|
| Skimmed Milk | 36.33% |
| SMP | 4.45% |
| Cream | 11.14% |
| Water from syrup | 13.66% |
| Ferment | 0.01% |
| Polyol | Xylitol: 4.58% |
| Emulsifier | LACTEM: 0.42% |
| Gelling and/or thickening agent | Xantane: 0.35% |
| Sugar | Saccharose: 3.70% |
| | Glucose: 10.56% |
| Other | Polydextrose: 2.82% |
| Fruit preparation | 12% |
| Dry Matter | 42% |
| Fat content (per 100 g) | 5.3 g |
| Overrun | 33% |

### Procedure:

The procedure involves mixing 40% by weight of syrup c) prepared as follows, and 60% by weight of the white mass b) prepared as follows. The mixture is referred to as mix d).

Syrup c): 38.8% water, 8% cream, 30% glucose, 13% xylitol, 8% polydextrose, 1% xantane and 1.2% LACTEM are mixed and hydrated during 1 hour at room temperature. Then the mixture is pre-heated at 63° C., homogenized at 100 bars, sterilized at 132° C., and then cooled at 9° C.
White mass b): The ingredients are mixed and pre-heated at 80° C., pasteurized at 92° C., homogenized at 150 bars. Then the ferment is inoculated, and the mixture is allowed to ferment at 43° C. during 6-8 hours, and then cooled to 9° C.
Mix d): Syrup c) and white mass b) are mixed, and cooled at 4° C. Then the mixture undergoes maturation during 5 hours at 5-10° C., and aeration (apparatus available at Mondomix) at a temperature of 4° C., to achieve the overrun. Then the fruit preparation is added.

### Example 6

The composition reported on table V is prepared, stored and then frozen.

The procedure for making the composition is detailed below.

TABLE V

| Ingredient | Example 6: |
|---|---|
| Skimmed Milk | 30.27% |
| SMP | 3.71% |
| Cream | 10.77% |
| Water from syrup | 17.12% |
| Ferment | 0.01% |
| Polyol | Xylitol: 4.40% |
| Emulsifier | LACTEM: 0.53% |
| Gelling and/or thickening agent | Gelatin: 0.85% |
| | Xanthan: 0.26% |
| Sugar | Sugar: 3.08% |
| | Glucose: 6.82% |
| | Lactose: 6.60% |
| Other | Polydextrose: 3.56% |
| Fruit preparation | 12% |
| Dry Matter | 42% |
| Fat content (per 100 g) | 5 g |
| Overrun | 66% |

### Procedure:

The procedure involves mixing 50% by weight of syrup c) prepared as follows, and 50% by weight of the white mass b) prepared as follows. The mixture is referred to as mix d).

Syrup c): water, cream, glucose, lactose, xylitol, polydextrose, gelatin, xantane and LACTEM are mixed and hydrated during 1 hour at room temperature. Then the mixture is pre-heated at 63° C., homogenized at 100 bars, sterilized at 132° C., and then cooled at 5° C.
White mass b): The other ingredients are mixed and pre-heated at 80° C., pasteurized at 92° C., homogenized at 150 bars. Then the ferment is inoculated, and the mixture is allowed to ferment at 43° C. during 6-8 hours, and then cooled to 9° C.
Mix d): Syrup c) and white mass b) are mixed, and cooled at 4° C. Then the mixture undergoes maturation during 5 hours at 5-9° C., and aeration (apparatus available at Mondomix) at a temperature of 4° C., to achieve the overrun. Then the fruit preparation is added.

1. The use of a dairy composition comprising milk, stored at a temperature of from 0.5 to 10° C., for preparing a frozen composition by freezing at a temperature of from −25° C. to −0.5° C.,
wherein:
the composition comprises gas inclusions, and
the composition has an overrun of from 25% to 150%, preferably of from 25% to 50% or of from 50% to 150% or of from 75% to 125%.

2. The use according to claim 1, wherein the composition is a fermented or non fermented dairy composition.

3. The use according to claim 1, wherein the composition comprises:
a) milk,
b) cream,
c) a polyol,
d) an emulsifier,
e) optionally a gelling and/or thickening agent, and
f) optionally a taste additive.

4. The use according to claim 3 wherein the polyol is xylitol.

5. The use according to claim 3, wherein the emulsifier is an ester of a fatty acid glyceride.

6. The use according to claim 3, wherein the emulsifier is a lactic acid ester of mono- and diglycerides of fatty acids.

7. The use according to claim 3, wherein the composition comprises a gelling and/or thickening agent which is gelatin and/or xanthan.

8. The use according to claim 1, wherein the composition comprises a taste additive comprising sugar.

9. The use according to claim 3, wherein the composition comprises:
from 2% to 12% by weight, preferably from 2% to 4%; or from 4% to 12%, or from 5% to 10%, of a polyol c),
from 0.1 to 3% by weight, preferably from 0.25 to 1.5%, of an emulsifier d),
if present, from 0.1 to 3% by weight, preferably from 0.25 to 1.5%, of a gelling and/or thickening agent e),
and wherein the composition comprises:
a dry matter of from 25 to 67% by weight, and
a fat content of from higher than 0% to 20% by weight, preferably from higher than 0% to 3% or from 3% to 20%.

10. The use according to claim 3, wherein the composition comprises:
from 20 to 70% by weight of milk a),
from higher than 0% to 50% by weight, preferably from higher than 0% to 5% or from 5% to 40% or from 40% to 50%, of cream b),
from 5 to 25% by weight of a taste additive f), preferably sugar,
and wherein:
the composition has a dry matter of from 37% to 60% by weight, and
the composition has a fat content of from higher than 0% to 20% by weight, preferably from higher than 0% to 5% or from 5% to 15% or from 15% to 20%.

11. The use according to claim 1 wherein freezing is performed without any agitation, during from 4 to 6 hours, at a temperature of from −20 to −15° C.

12. The use according to claim 1 wherein freezing is performed during 5 hours at a temperature of from −20 [symbol] to −18° C.

13. The use according to claim 1 wherein freezing is performed in a domestic freezer.

14. The use according to claim 1, wherein the dairy composition is comprised in a container.

15. The use according to claim 14, wherein the container is closed with a seal.

16. The use according to claim 14, wherein the container presents written instructions and/or suggestions to freeze it.

17. dairy composition comprising:
a) milk,
b) cream,
c) Xylitol,
d) an emulsifier,
e) a gelling and/or thickening agent, and
f) optionally a taste additive, preferably sugar,
wherein:
the composition comprises gas inclusions, and
the composition has an overrun of from 25% to 150%, preferably of from 25% to 50% or of from 50% to 150% or of from 75% to 125%.

18. A dairy composition according to claim 17, wherein the emulsifier is a lactic acid ester of mono- and diglycerides of fatty acids.

19. A dairy composition according claim 17, wherein the gelling and/or thickening agent is gelatin and/or xanthan.

20. A dairy composition according to claim 17, wherein the composition comprises:
from 2% to 12% by weight, preferably from 2% to 4% or from 4% to 12% or from 5% to 10%, of xylitol c),
from 0.1 to 3% by weight, preferably from 0.25 to 1.5%, of an emulsifier d),
from 0.1 to 3% by weight, preferably from 0.25 to 1.5%, of a gelling agent e),
and wherein the composition comprises:
a dry matter of from 25 to 67% by weight, and
a fat content of from higher than 0% to 20% by weight, preferably from higher than 0% to 3% or from 3% to 20%.

21. A dairy composition according to claim 17, wherein the composition comprises:
from 20 to 70% by weight of fermented milk a),
from higher than 0% to 50% by weight, preferably form higher than 0% to 5% or from 5% to 40% or from 40% to 50%, of cream b),
from 5 to 25% by weight of a taste additive f), preferably sugar,
and wherein:
the composition has a dry matter of from 37 to 60% by weight, and
the composition has a fat content of from 3% to 20% by weight, preferably from 3% to 5% or from 5% to 15% or from 15% to 20%.

22. A process of preparing a dairy composition as defined in claim 3, comprising the steps of:
Step A): mixing all the components a), to d), optionally e) and optionally f),
Step B): subjecting the mixture obtained at step A) to a gas, to provide the overrun,
Step C): introducing the composition obtained at step B) in a container and sealing the container,
Step D): storing the composition in the container obtained at step C) at a temperature of from 0.5 to 10° C. during at least 2 days.

23. A process of preparing a frozen composition, comprising the process of claim 22, followed by a further step E) comprising freezing the composition obtained at step D) at a temperature of from −25° C. to −0.5° C.

24. A process according to claim 23 wherein freezing is performed without agitation.
